(19) United States
(12) Patent Application Publication
(10) Pub. No.: US 2026/0163743 A1
(43) Pub. Date: Jun. 11, 2026

(54) SYSTEM FOR PREVENTING BYTE-LEVEL HASH COMPUTATION DISCREPANCIES IN DISTRIBUTED REVIEW VERIFICATION THROUGH DETERMINISTIC CANONICALIZATION WITH IMMUTABLE DELTA LINEAGE

(71) Applicant: ÖNDER LEVENTOGLU, IZMIR (TR)

(72) Inventor: ÖNDER LEVENTOGLU, IZMIR (TR)

(21) Appl. No.: 19/319,221

(22) Filed: Sep. 4, 2025

(51) Int. Cl. H04L 9/32

(52) U.S. Cl. CPC H04L 9/3236; H04L 9/3218

(57) ABSTRACT

A system and method prevent byte-level hash drift in distributed review verification by performing deterministic canonicalization before parsing to produce a canonical byte sequence for each record and computing a salted commitment bound to a Canonicalization Program Identifier (CPI). Per-record commitments are aggregated into a batch root anchored to a public blockchain transaction or log field. An append-only delta lineage links changes by prior-state digests, enabling reconstruction without in-place mutation. A verification interface returns selective inclusion proofs and receipts that can be validated without full nodes under a weighted multi-ledger confirmation policy. Optional features include attested receipts from trusted hardware, credential binding for reviewer tiers with policy-gated actions, redaction custody continuity via link tokens, and zero-knowledge assertions. The approach eliminates hash drift, reduces verification bandwidth, and enables independent integrity verification on resource-constrained devices.

### CROSS-REFERENCE TO RELATED APPLICATIONS

This application is related to co-pending applications under the Certified Independent Reviewer System (CIRS), including: (i) System and Method for Real-Time Online Review Fraud Detection Using Fraud-Aware Selective Attention with Multi-Tier Verification; (ii) Privacy-Preserving Location Verification System and Method; (iii) Multi-Tier Stance Clarity Verification System; and (iv) Distributed Trust Score (CTS) Calculation System. The entire disclosures of the foregoing are incorporated by reference.

### STATEMENT REGARDING FEDERALLY SPONSORED RESEARCH

Not applicable.

### TECHNICAL FIELD

The disclosure relates to cryptographic data integrity systems for distributed computing networks, specifically systems that prevent byte-level hash computation discrepancies through deterministic canonicalization executed before parsing, enable tamper-evident anchoring of compact commitments, and provide independent light-client verification with immutable delta lineage tracking.

### BACKGROUND

Centralized repositories of online reviews are susceptible to undetected edits, selective deletions, and silent rewrites that undermine market trust. Public blockchains provide append-only ledgers and globally verifiable timestamps, but naively storing plaintext reviews on-chain is cost- and privacy-prohibitive.

Technical problem-hash drift. Semantically identical content can hash differently across heterogeneous stacks due to differences in Unicode normalization, line endings, JSON key ordering, numeric serialization, timestamp formats, and null/boolean encodings. This hash drift prevents reliable cross-system verification unless inputs are transformed by a deterministic canonicalization protocol.

Technical problem specificity. Hash drift is a problem unique to distributed computing systems where identical semantic content produces different cryptographic outputs due to byte-level encoding differences. For example, UTF-8 NFC “e” (0×C3 0×A9) versus NFD “e+combining acute accent” (0x 65 0xCC 0x81) produces different SHA-256 hashes despite representing the same character. This problem cannot be solved by human mental processes; it requires deterministic byte-level transformations executed by processors.

Cross-platform review verification failures are a recognized industry challenge. There is a need for a review-specific system that (i) eliminates cross-system hash variance through byte-level transformations executed before parsing operations, (ii) provides field-granular proofs with bounded proof effort, (iii) maintains immutable lineage across edits through append-only delta tracking, (iv) anchors compact batch commitments under size/time policy, and (v) enables multi-ledger acceptance for increased integrity confidence.

### SUMMARY

Disclosed embodiments perform byte-level canonicalization before parsing to prevent parser-state discrepancies, compute salted per-record commitments that bind a Canonicalization Program Identifier (CPI), aggregate commitments into a batch root, anchor the root in a public blockchain transaction or log field, maintain an append-only delta lineage for audit, and provide selective inclusion proofs that verifiers can validate without full nodes under a weighted multi-ledger confirmation policy. Optional features include attested receipts (trusted hardware), credential binding for reviewer tiers, redaction custody continuity via link tokens, and zero-knowledge assertions.

### Definitions

Review event: structured record with identifiers, content digests, metadata, and moderation state.

Canonicalization rules: deterministic transformations preventing cross-system hash discrepancies by enforcing stable field order, UTC timestamps with “Z”, Unicode NFC normalization, deterministic numeric rounding, explicit nulls, lowercase booleans, and lexicographic key ordering.

Byte-level transformation protocol: ordered operations at the byte level (e.g., strict UTF-8 decode, NFC normalization, removal of zero-width characters, line-ending normalization) that execute before parsing to prevent parser-state dependencies.

CPI (Canonicalization Program Identifier): digest over canonicalization source and ruleset version; included in commitments and receipts so verifiers reject protocol mismatches.

Field-level digest: cryptographic hash of an individual field within the canonical record, enabling selective disclosure without revealing the complete record.

Batch root: aggregate commitment over multiple per-record commitments (e.g., Merkle root or vector-commitment root).

Batch parameters (size/time policy): size and/or timeout thresholds that close a batch to balance cost and latency.

Delta: append-only change record containing a prior-state digest pointer, updated field digests, timestamp, and operation type; enables reconstruction without in-place mutation.

Weighted multi-ledger confirmation policy: acceptance rule derived from a weighted combination of confirmations across independent public blockchains.

Parser-state dependency: structural variation caused by non-canonical input affecting parser decisions that cannot be reconciled post-hoc.

Append-only delta lineage: immutable sequence of deltas forming a verifiable chain of state transitions.

Credential binding: cryptographic linkage between reviewer credentials (e.g., IR/IPR) and canonical artifacts, with credential lifecycle events optionally anchored.

Selective disclosure: proving properties of specific fields via inclusion proofs without exposing full records.

Resource-bounded verification: verification completing within practical memory/time on a mobile-class device, without full blockchain histories.

### BRIEF DESCRIPTION OF THE DRAWINGS

FIG. 1—System architecture including canonicalization, field digests, batching, anchoring, receipts, lineage, and verification.

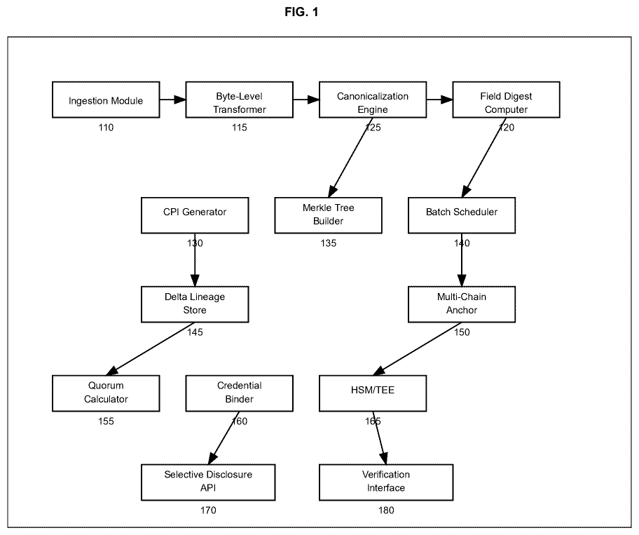

FIG. 2—Byte-level transformation flow that prevents parser-state dependency.

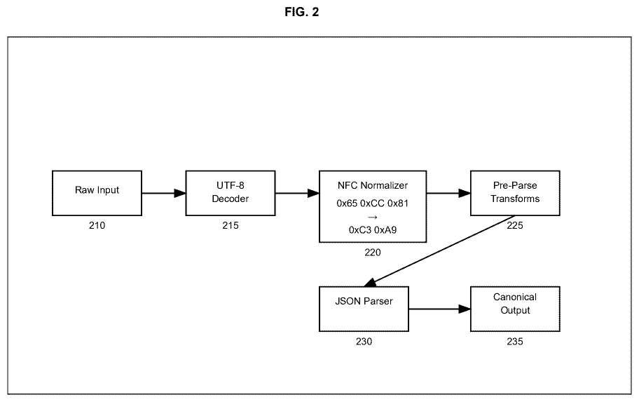

FIG. 3—Field-level digests to Merkle/vector root; selective proof generation.

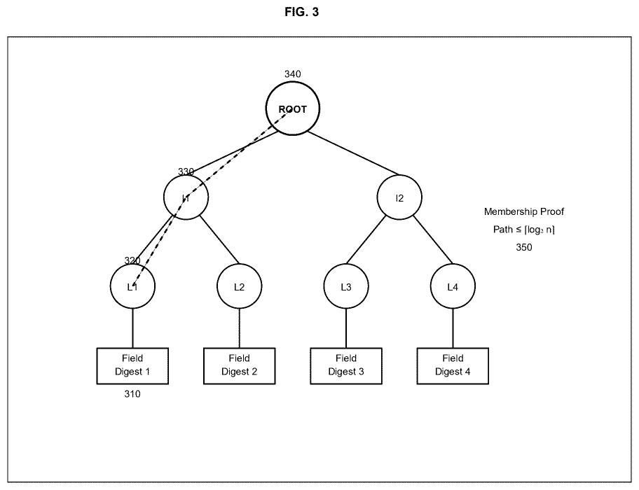

FIG. 4—Batch closure under size/time policy; anchor submission; receipt recording.

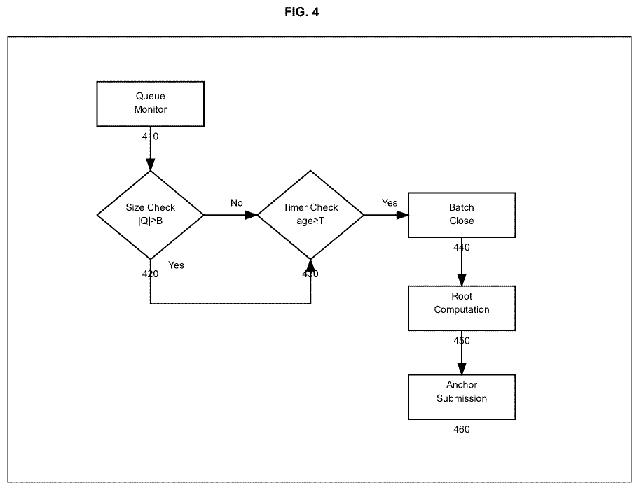

FIG. 5—Delta lineage and reconstruction from an anchored base.

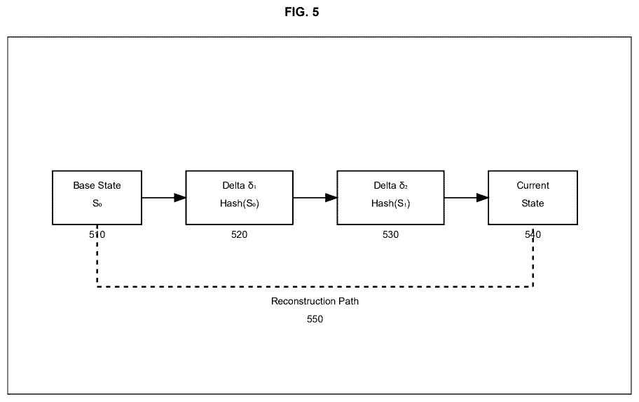

FIG. 6—Weighted multi-ledger confirmation policy and integrity indication.

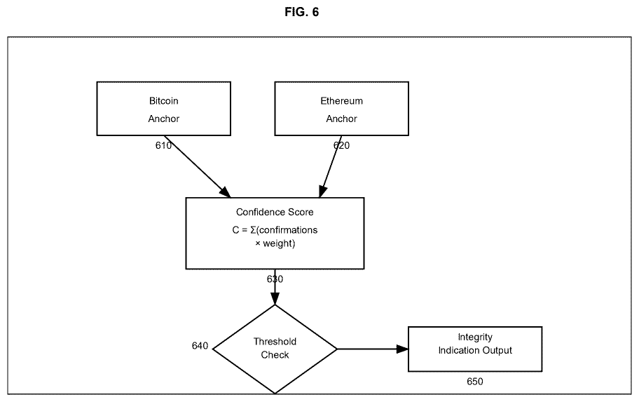

FIG. 7—Selective disclosure interface and verifier workflow (no full node).

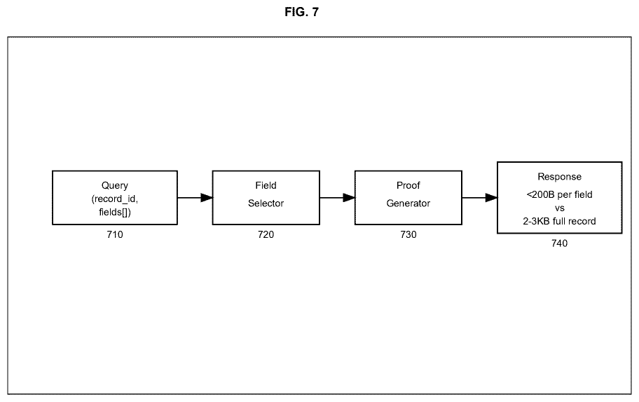

FIG. 8—Credential binding (IR/IPR) with anchored lifecycle.

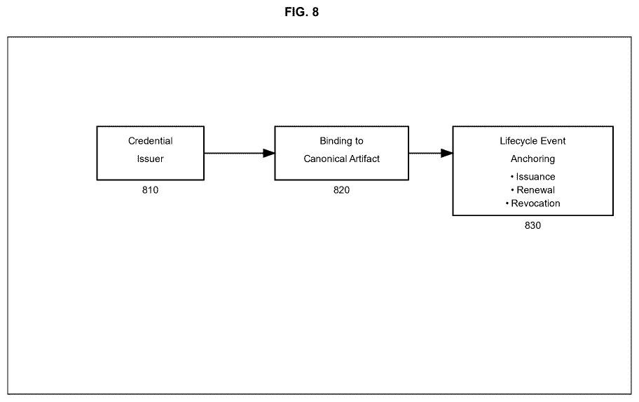

FIG. 9—Attested receipts (trusted hardware) and allow-list verification.

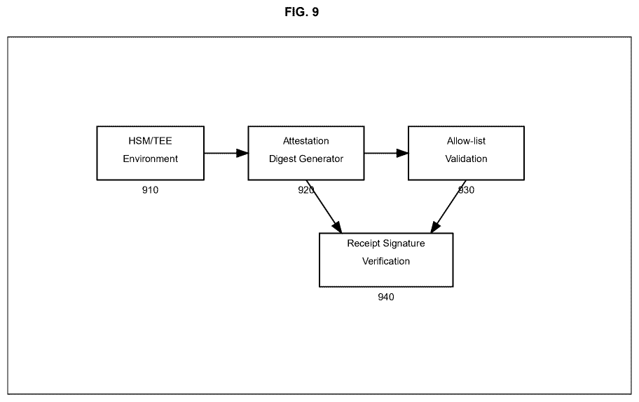

FIG. 10—Cost/latency trade-offs for batch size/time policy.

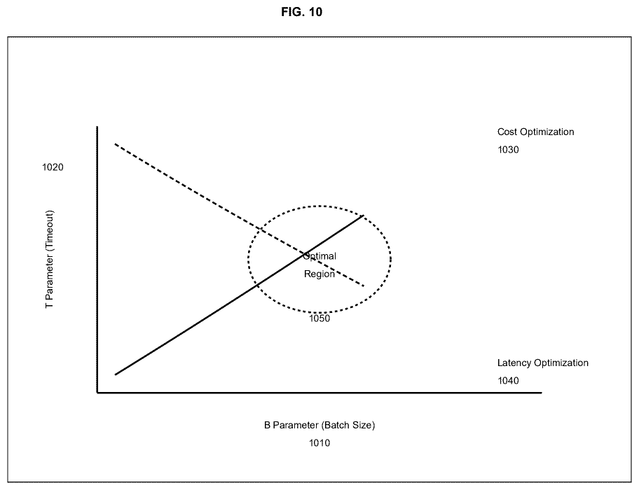

FIG. 11—Redaction with custody continuity (link token).

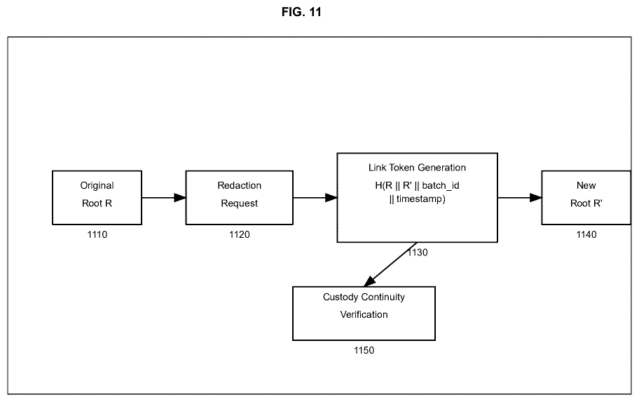

FIG. 12—Optional zero-knowledge assertions on fields.

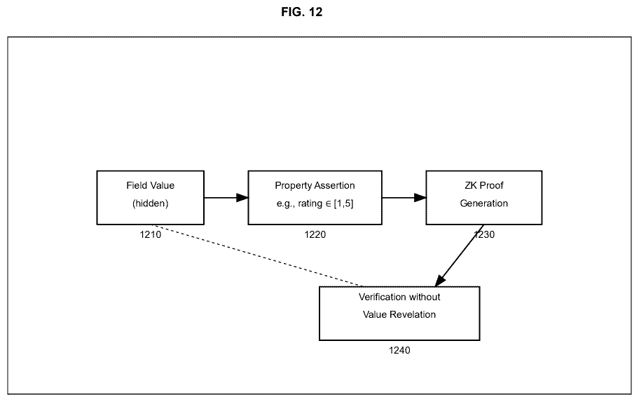

### DETAILED DESCRIPTION

### Canonicalization & Hash-Drift Prevention

An ingestion module receives review events through authenticated interfaces. A canonicalization engine executes byte-level transformations before parsing, including strict UTF-8 decode with error rejection, Unicode NFC normalization, removal of byte-order marks and zero-width characters, normalization of line endings to LF, and whitespace trimming. Only after these byte operations does the system parse structured content under a strict profile, establish a stable field order, normalize timestamps to UTC with “Z”, deterministically round numeric fields, enforce explicit nulls and lowercase booleans, and serialize to a deterministic canonical byte sequence.

The system computes a CPI over the ruleset and code identifiers and binds the CPI into a salted commitment per canonical record. Salts are generated by cryptographically secure sources; reuse can be detected using probabilistic structures. Commitments are associated with human-readable artifacts in an off-chain store.

### Canonicalization Edge Cases (Illustrative and Non-Limiting)

Unicode/bidi/confusables: Strip or reject bidi control marks and non-characters; optionally map common confusables to canonical forms for comparison-only (not for hashing).
Numeric forms: Disallow NaN/+/− Infinity; parse decimals with round half-even; canonicalize integers without leading zeros; forbid locale separators; cap exponent range with explicit error.
Timestamps: Require RFC 3339 with “Z”; reject leap-second “: 60”; allow sub-millisecond precision only if truncated to a declared scale (e.g., milliseconds).
Binary fields: Use base64url without padding; represent zero-length as an empty string; reject invalid alphabet.
Map-key ordering: Sort by UTF-8 byte order (stable comparator) and document as part of CPI.
Whitespace policy: Collapse only non-semantic padding at the byte layer; do not alter internal string content beyond NFC normalization.

```
Canonicalization Pseudocode (illustrative)
function canonicalize_and_commit(input_bytes, ruleset_version):
  bytes1 = strict_utf8_decode(input_bytes) // reject on error
  bytes2 = unicode_nfc_normalize(bytes1)
  bytes3 = remove_bom_and_zero_width(bytes2)
  bytes4 = normalize_line_endings_to_LF(bytes3)
  bytes5 = trim_nonsemantic_padding(bytes4)
  obj = strict_json_parse(bytes5) // RFC-compliant
  obj′ = apply_field_policies(obj) // UTC Z, rounding, nulls, booleans
  obj″ = sort_maps_by_utf8_key(obj′) // stable
  canon = json_serialize_deterministic(obj″) // stable bytes
  cpi = digest(ruleset_version ∥ code_hash( ))
  salt = csprng(32) // track reuse probabilistically
  C = digest(salt ∥ cpi ∥ canon)
  return (canon, cpi, salt, C)
```

Test Vectors (abridged; illustrative)
TV1 (NFC vs NFD): Input A: {“text”: “cafe”}; Input B: {“text”: “cafe\u0301”}→identical canon bytes; same C with different salts.
TV2 (line endings): CRLF vs LF→identical canonical bytes.
TV3 (numeric rounding): {“score”: 4.005}→canonical 4.00 (half-even at two decimals, example policy).

### Batching, Anchoring & Receipts

A batcher aggregates per-record commitments and computes a batch root. A size/time policy closes a batch to balance anchor cost and latency. Anchoring may encode the root in a transaction or event-log field of a public blockchain; specific formats are implementation choices (illustrative and non-limiting). The system persists receipts (chain/transaction identifiers, block metadata, confirmation depth, CPI reference) and may include attestation digests produced in trusted hardware.

### Immutable Delta Lineage & Reconstruction

The system maintains append-only deltas (prior-state pointer, updated field digests, timestamp, operation type). For reconstruction at time t, the verifier selects an anchored base prior to t, verifies each delta pointer, applies updates, and authenticates the resulting digests against an anchored root-without in-place mutation. Numerical thresholds and timing examples herein are illustrative and non-limiting.

### Verification Without Full Nodes

A verification interface accepts a record identifier and field selectors and returns selective inclusion proofs with the corresponding receipts. A relying party validates compact chain proofs, checks CPI equality, evaluates the multi-ledger policy, recomputes field digests as needed, and authenticates to the batch root-completing within practical resource bounds on a mobile-class device.

### Optional Features

Credential binding (IR/IPR). Issuance and revocation events may be anchored; a policy gate can require verification success and non-revoked credentials for automated actions.

Redaction custody continuity. A link token can deterministically bind prior and new roots during lawful takedowns; optional zero-knowledge assertions can prove that only declared fields changed.

### Multi-Ledger Policy-Failure Modes (Illustrative)

Reorg handling: If a confirmation rollback exceeds a policy depth, recompute integrity indication and re-evaluate acceptance.

Liveness loss: If a chain fails liveness beyond a policy timeout, set its weight to zero until recovered.

Diversity rule: Require confirmations from at least two independent chains for acceptance (when configured).

Weight sources: Weights may reflect cost, historical reorg depth, validator set size, or finality guarantees (illustrative only).

Attested Receipt Verification Flow (illustrative)

(1) Retrieve receipt and included attestation digest; (2) verify chain inclusion via compact headers/proofs; (3) verify CPI equality; (4) validate attestation against operator allow-list; (5) check signature over receipt fields from a key bound to the attested environment; (6) output accept/reject with diagnostics.

### CPI Lifecycle (Compatibility & Migration)

A CPI identifies a canonicalization ruleset version and implementation. Upgrades produce a new CPI; verifiers: (i) accept proofs only when receipt.CPI==proof.CPI; (ii) support multiple CPIs concurrently; (iii) deprecate CPIs via allow-list changes and policy; (iv) expose CPI mismatch as a hard reject with a clear error.

### Security Considerations (Illustrative)

Salt uniqueness & DoS bounds: Bloom filter or similar probabilistic structure detects reuse; bound memory and false positives; on suspected collision, regenerate salt and log.

Pepper custody & rotation: Keys/peppers reside in trusted modules; rotations are logged and anchored; receipts indicate key epoch.

Link-token replay defense: Link tokens bind prior/new roots, batch id, timestamp, and signer-set commitment; verifiers reject replays outside the recorded transition window.

### Verifier API (Illustrative Schema)

```
    Request: GET /verify?record_id=...&fields=[...]
Response (JSON):
{
  “record_id”: “string”,
  “cpi”: “hex”,
  “accept”: true,
  “integrity_indication”: “string”,
  “proofs”: [{“field”:“rating”,“proof”:“base64”}],
  “receipt”: {“chain”:“string”,“tx_id”:“string”,“block”:“string”,“confirmations”:123},
  “errors”: [ ]
}
```

Error codes may include CPI_MISMATCH, ATTESTATION_INVALID, CHAIN PROOF_FAILED, POLICY_NOT SATISFIED.

### Examples (Illustrative and Non-Limiting)

Proof size: Per-field proofs may be tens to a few hundred bytes versus multi-kilobyte records.

Batch policy: Representative thresholds amortize anchor cost while preserving freshness.

Vector commitments: Constant-size proofs are viable when budgets are tight; Merkle remains an alternative.

### Privacy & Security

Personally identifiable information can be excluded from canonical artifacts; where linkage is needed, commitments or encrypted references are used. Interfaces are authenticated and rate-limited. Attestations, when present, are checked against an operator allow-list.

### Non-Obviousness Contrast

Unlike generic blockchain logging, this disclosure's byte-before-parse canonicalization with CPI binding eliminates cross-stack hash drift and-combined with selective proofs, append-only lineage, redaction continuity, and multi-ledger acceptance-enables independent verification without full nodes.

1. A system for preventing byte-level hash computation discrepancies in distributed review verification, the system comprising: (a) a canonicalization engine configured to perform byte-level transformations before parsing to produce, for each review record, a deterministic canonical byte sequence that eliminates encoding and parser-state discrepancies, including application of a versioned protocol domain-separation string (DS_CONTEXT) and ordered field processing to render a deterministic canonical representation across nodes, the byte-level transformations comprising strict UTF-8 decode with error rejection, Unicode NFC normalization, removal of byte-order marks and zero-width characters, normalization of line endings to LF, and whitespace trimming, executed prior to any parsing; (b) a commitment generator configured to compute a salted cryptographic commitment for each canonical record and to bind a Canonicalization Program Identifier (CPI) and a versioned DS_CONTEXT identifying a canonicalization ruleset version; (c) a batch module configured to aggregate per-record commitments into a batch root and to anchor the batch root to a public blockchain transaction or log field; (d) a lineage component configured to persist write-once deltas linked by prior-state digests to enable reconstruction of historical states without in-place mutation; and (e) a verification interface configured to return record inclusion proofs and to accept or reject based on CPI equality and a weighted multi-ledger confirmation policy, without requiring a full node, wherein the canonicalization and commitment pipeline is deterministic such that inputs differing only by field ordering or locale formatting are rendered to an identical canonical representation across nodes, yielding identical commitments for semantically equivalent inputs.

2. A computer-implemented method for preventing byte-level hash computation discrepancies in distributed review verification, the method comprising: performing byte-level transformations before parsing to obtain a deterministic canonical byte sequence for a review record, the transformations comprising strict UTF-8 decode with error rejection, Unicode NFC normalization, removal of byte-order marks and zero-width characters, normalization of line endings to LF, and whitespace trimming; deterministically canonicalizing input fields using a versioned protocol domain-separation string (DS_CONTEXT) and ordered field processing, including normalizing timestamps to a common time base with fixed precision and normalizing currency values to a canonical numeric and currency-code pair to remove locale and formatting variance; computing a salted commitment that binds a CPI and a versioned DS_CONTEXT; computing the commitment over the canonical representation such that inputs differing only by field ordering or locale formatting are mapped to an identical canonical form across nodes; aggregating per-record commitments into a batch root; anchoring the batch root to a public blockchain transaction or log field; persisting write-once deltas linked by prior-state digests; and returning selective inclusion proofs and receipts enabling verification under a weighted multi-ledger confirmation policy without a full node.

3. The system of claim 1, wherein parsing after the byte-level transformations applies a strict profile with stable field ordering, UTC timestamps with “Z”, deterministic numeric rounding, explicit nulls, and lowercase booleans.

4. The system of claim 1, wherein salts are generated by a cryptographically secure source and reuse is detected using a probabilistic structure.

5. The system of claim 1, further comprising attested receipts generated inside trusted hardware, and the verification interface rejects when an attestation digest is not present in an allow-list.

6. The system of claim 1, wherein the verification interface returns field-specific inclusion proofs and a bandwidth-reduction indication relative to full-record transfer.

7. The system of claim 1, wherein the batch module closes a batch under a size policy and a time policy to balance anchor cost and latency.

8. The system of claim 1, wherein the weighted multi-ledger confirmation policy derives an integrity confidence indication from confirmations across independent public blockchains.

9. The system of claim 1, wherein the batch root is a Merkle tree root, and an inclusion proof comprises a bounded number of sibling hashes sufficient to authenticate a selected record to the root.

10. The system of claim 1, wherein the batch root is a vector-commitment root that enables constant-size inclusion proofs in some embodiments.

11. The system of claim 1, wherein canonicalization emits a canonicalization log sufficient to reproduce the canonical byte sequence for audit.

12. The system of claim 1, wherein the CPI is recorded with each commitment and each receipt, and the verification interface rejects upon CPI mismatch.

13. The system of claim 1, wherein the lineage component supports reconstruction of a state at a requested time by applying ordered deltas from an anchored base, and upon redaction the system records a link token that binds a prior batch root to a new batch root.

14. The system of claim 1, further comprising optional zero-knowledge assertions that prove a property of a selected field without revealing plaintext.

15. The system of claim 1, wherein a credential service issues and revokes reviewer credentials for IR and IPR tiers and records credential status changes as anchored events queryable during verification.

16. The system of claim 1, wherein a policy gate approves an automated action only upon verification success, CPI equality, satisfaction of the multi-ledger policy, and a non-revoked credential at decision time.

17. The method of claim 2, further comprising reducing per-record cost via batch amortization and reducing verification bandwidth by returning field-specific proofs in lieu of full records.

18. The method of claim 2, further comprising providing a programmatic API that, given a record identifier and field selectors, returns inclusion proofs, a receipt, and an acceptance outcome.

19. The system of claim 1, wherein reviewer credentials include tier designations, and wherein the canonicalization engine normalizes credential fields, including time-zone and format normalization, to prevent cross-node verification discrepancies.

20. The system of claim 1, wherein the canonicalization pipeline is deterministic such that inputs differing only by locale formatting or field ordering are rendered to an identical canonical representation, yielding identical cryptographic commitments across nodes and enabling consensus on trust contributions without central coordination.
